(19) United States
(12) Patent Application Publication
(10) Pub. No.: US 2025/0184186 A1
(43) Pub. Date: Jun. 5, 2025

(54) RADIO RECEIVER WITH MULTI-STAGE EQUALIZATION

(71) Applicant: Nokia Solutions and Networks Oy, Espoo (FI)

(72) Inventors: Mikko Johannes HONKALA, Espoo (FI); Dani Johannes KORPI, Espoo (FI); Janne Matti Juhani HUTTUNEN, Espoo (FI)

(21) Appl. No.: 18/867,674

(22) PCT Filed: Jun. 7, 2022
(86) PCT No.: PCT/EP2022/065350

§ 371 Date: Nov. 20, 2024

(51) Int. Cl. H04L 25/02; H04L 25/03

(52) U.S. Cl. CPC H04L 25/0254; H04L 25/03159; H04L 25/03165; H04L 2025/03414; H04L 2025/03522

(57) ABSTRACT

Various example embodiments may relate to relate radio receivers. A radio receiver may receive data and reference signals; determine a channel estimate for the received data based on the reference signals; and equalize the received data with a sequential plurality of equalization stages, one or more of the sequential plurality of equalization stages comprising: an equalizer configured to determine an equalized representation of input data based a previous channel estimate, and a channel estimator neural network configured to determine at least a refined channel estimate for a subsequent equalization stage based on the previous channel estimate and the input data.

### TECHNICAL FIELD

Various example embodiments generally relate to radio receivers. Some example embodiments relate to equalization of received signals by multiple neural network-based equalization stages.

### BACKGROUND

Radio receivers may be implemented with mathematical and statistical algorithms. Such receiver algorithms may be developed and programmed manually, which may be labour intensive. For example, a lot of manual work may be needed to adapt the receiver algorithms to different reference signal configurations. Receiver algorithms designed this way may perform adequately for some radio channel conditions but they may not provide the best possible performance in all situations.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Example embodiments enable to improve reliability of random access to a non-terrestrial network and thereby to speed up the random access process. These benefits may be achieved by the features of the independent claims. Further implementation forms are provided in the dependent claims, the description, and the drawings.

According to a first aspect, a radio receiver is disclosed. The radio receiver may comprise: at least one processor; and at least one memory storing instructions that, when executed by the at least one processor, cause the radio receiver at least to: receive data and reference signals; determine a channel estimate for the received data based on the reference signals; and equalize the received data with a sequential plurality of equalization stages, one or more of the sequential plurality of equalization stages comprising: an equalizer configured to determine an equalized representation of input data based a previous channel estimate, and a neural network configured to determine at least a refined channel estimate for a subsequent equalization stage based on the previous channel estimate and the input data.

According to an example embodiment of the first aspect, the neural network is configured to output a hidden state to a neural network of the subsequent equalization stage.

According to an example embodiment of the first aspect, the input data of the one or more of the sequential plurality of equalization stages comprises the received data.

According to an example embodiment of the first aspect, one or more of the sequential plurality of equalization stages is configured to determine an updated representation of the received data for the subsequent equalization stage, and the input data of the subsequent equalization stage comprises the updated representation of the received data.

According to an example embodiment of the first aspect, the neural network is obtainable by training the neural network based on a loss function comprising: an output of the radio receiver, and a difference between an output of the sequential plurality of equalization stages and transmitted data symbols.

According to an example embodiment of the first aspect, the neural network is obtainable by training the neural network based on a loss function comprising: an output of the radio receiver, and differences between outputs of the equalizers of the sequential plurality of equalization stages and transmitted data symbols.

According to an example embodiment of the first aspect, the loss function comprises weights for the differences between the outputs of the equalizers and transmitted data symbols, wherein the weights increase along with an order of equalization stage.

According to an example embodiment of the first aspect, the loss function comprises a minimum mean square error between an output of at least one of the equalizers of the plurality of equalization stages and the transmitted data symbols.

According to an example embodiment of the first aspect, the output of the radio receiver comprises log-likelihood ratios of bits carried by the transmitted data symbols, and wherein the loss function comprises a binary cross entropy of a sigmoid function of the log-likelihood ratios.

According to an example embodiment of the first aspect, the equalizer comprises a non-trainable equalizer.

According to an example embodiment of the first aspect, the non-trainable equalizer comprises a maximum-ratio combiner or a linear minimum mean square error equalizer.

According to an example embodiment of the first aspect, the equalizer comprises an equalizer neural network.

According to an example embodiment of the first aspect, the equalizer neural network is obtainable by training the equalizer neural network based on the loss function.

According to an example embodiment of the first aspect, the neural network and/or the equalizer neural network comprise a real-valued convolutional neural network with depthwise convolutions.

According to an example embodiment of the first aspect, at least two of the equalizers of the sequential plurality of equalization stages are of different types, comprise separate neural networks or sub-networks, or include shared neural network layers.

According to an example embodiment of the first aspect, the radio receiver comprises a mobile device or an access node.

According to a second aspect, a method is disclosed. The method may comprise: receiving data and reference signals; determining a channel estimate for the received data based on the reference signals; and equalizing the received data with a sequential plurality of equalization stages, one or more of the sequential plurality of equalization stages comprising: determining, by an equalizer, an equalized representation of input data based a previous channel estimate, and determining, by a neural network, at least a refined channel estimate for a subsequent equalization stage based on the previous channel estimate and the input data.

According to an example embodiment of the second aspect, the method may comprise: outputting, by the neural network, a hidden state to a neural network of the subsequent equalization stage.

According to an example embodiment of the second aspect, the input data of the one or more of the sequential plurality of equalization stages comprises the received data.

According to an example embodiment of the second aspect, the method may comprise: determining, by one or more of the sequential plurality of equalization stages, an updated representation of the received data for the subsequent equalization stage, wherein the input data of the subsequent equalization stage comprises the updated representation of the received data.

According to an example embodiment of the second aspect, the method may comprise: training the neural network based on a loss function comprising: an output of the radio receiver, and a difference between an output of the sequential plurality of equalization stages and transmitted data symbols.

According to an example embodiment of the second aspect, the method may comprise: training the neural network based on a loss function comprising: an output of the radio receiver, and differences between outputs of the equalizers of the sequential plurality of equalization stages and transmitted data symbols.

According to an example embodiment of the second aspect, the loss function comprises weights for the differences between the outputs of the equalizers and transmitted data symbols, wherein the weights increase along with an order of equalization stage.

According to an example embodiment of the second aspect, the loss function comprises a minimum mean square error between an output of at least one of the equalizers of the plurality of equalization stages and the transmitted data symbols.

According to an example embodiment of the second aspect, the output of the radio receiver comprises log-likelihood ratios of bits carried by the transmitted data symbols, and wherein the loss function comprises a binary cross entropy of a sigmoid function of the log-likelihood ratios.

According to an example embodiment of the second aspect, the equalizer comprises a non-trainable equalizer.

According to an example embodiment of the second aspect, the non-trainable equalizer comprises a maximum-ratio combiner or a linear minimum mean square error equalizer.

According to an example embodiment of the second aspect, the equalizer comprises an equalizer neural network.

According to an example embodiment of the second aspect, the method may comprise: training the equalizer neural network based on the loss function.

According to an example embodiment of the second aspect, the neural network and/or the equalizer neural network comprise a real-valued convolutional neural network with depthwise convolutions.

According to an example embodiment of the second aspect, at least two of the equalizers of the sequential plurality of equalization stages are of different types, comprise separate neural networks or sub-networks, or include shared neural network layers.

According to an example embodiment of the second aspect, the method is performed by a radio receiver, a mobile device, or an access node.

According to a third aspect, a computer program or a computer program is disclosed. The computer program or computer program product may comprise instructions for causing an apparatus to perform at least the following: receiving data and reference signals; determining a channel estimate for the received data based on the reference signals; and equalizing the received data with a sequential plurality of equalization stages, one or more of the sequential plurality of equalization stages comprising: determining an equalized representation of input data based a previous channel estimate, and determining, by a neural network, at least a refined channel estimate for a subsequent equalization stage based on the previous channel estimate and the input data. The computer program or the computer program product may comprise instructions for causing an apparatus to perform any example embodiment of the method of the second aspect.

According to a fourth aspect, a radio receiver may comprise: means for receiving data and reference signals; means for determining a channel estimate for the received data based on the reference signals; and means for equalizing the received data with a sequential plurality of equalization stages, one or more of the sequential plurality of equalization stages comprising: means for determining an equalized representation of input data based a previous channel estimate, and means for determining, by a neural network, at least a refined channel estimate for a subsequent equalization stage based on the previous channel estimate and the input data. The apparatus may comprise means for performing any example embodiment of the method of the second aspect.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a system model for radio transmission;

FIG. 2 illustrates an example of an apparatus configured to practice one or more example embodiments;

FIG. 3 illustrates an example of a multi-stage equalizer architecture;

FIG. 4 illustrates an example of a multi-stage equalizer architecture with update of received data;

FIG. 5 illustrates an example of data routing at a multi-stage equalizer architecture;

FIG. 6 illustrates an example of a method for equalizing received data;

FIG. 7 illustrates simulation results in case of 1-stage maximal ratio combiner (MRC); and

FIG. 8 illustrates simulation results in case of 5-stage MRC.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Neural networks may be trained to perform one or more tasks of a radio receiver, for example equalization, channel estimation, bit detection (demapping), or channel decoding. A neural network may comprise an input layer, one or more hidden layers, and an output layer. Nodes of the input layer may be connected to one or more of the nodes of a first hidden layer. Nodes of the first hidden layer may be connected to one or more nodes of a second hidden layer, and so on. Nodes of the last hidden layer may be connected to one or more nodes of an output layer. A node may be also referred to as a neuron, a computation unit, or an elementary computation unit. Terms neural network, neural net, network, and model may be used interchangeably.

A convolutional neural network may comprise at least one convolutional layer. A convolutional layer may extract information from input data, for example an array comprising received data symbols, to form a plurality of feature maps. A feature map may be generated by applying a filter or a kernel to a subset of input data and sliding the filter through the input data to obtain a value for each element of the feature map. The filter may comprise a matrix or a tensor, which may be for example multiplied with the input data to extract features corresponding to that filter. A plurality of feature maps may be generated based on applying a plurality of filters. A further convolutional layer may take as input the feature maps from a previous layer and apply the same filtering principle to generate another set of feature maps. Weights of the filters may be learnable parameters and they may be updated during training. An activation function may be applied to the output of the filter(s). The convolutional neural network may further comprise one or more other type of layers such as for example fully connected layers after and/or between the convolutional layers. An output may be provided by an output layer. ResNet is an example of a deep convolutional network.

A forward propagation or a forward pass may comprise feeding a set of input data through layers of the neural network and producing an output. During this process the learnable parameters of the neural network affect propagation of the data and thereby the output provided by the output layer. Neural networks and other machine learning models may be trained to learn properties from input data. Learning may be based on teaching the network by a training algorithm. In general, a training algorithm may include changing some properties of the neural network such that its output becomes as close as possible to a desired output. For example, in case of equalization, the output of the neural network may represent equalized data symbols. Training may be performed by changing the learnable parameters of the neural network such that the difference between the transmitted data symbols (training data) and output of the neural network is minimized, or at least reduced to an acceptable level.

During training the output of the neural network may be compared to the desired output, e.g. ground-truth data provided for training purposes, to compute an error value (loss). The error may be calculated based on a loss function. Updating the neural network may be then based on calculating a derivative with respect to learnable parameters of the neural network. This may be done for example using a backpropagation algorithm that determines gradients for each layer, starting from the final layer of the network until gradients for the learnable parameters of all layers have been obtained. Parameters of each layer may be updated accordingly such that the loss is iteratively decreased. Examples of losses include mean squared error, cross-entropy, or the like. In deep learning, training may comprise an iterative process, where at each iteration the algorithm modifies parameters of the neural network to make a gradual improvement of the network's output, that is, to gradually decrease the loss.

Training phase of the neural network may be ended after reaching an acceptable error level. In inference phase the trained neural network may be applied for a particular task, for example equalization, channel estimation, bit demapping, and/or channel decoding. One or more of such receiver algorithms or blocks may be implemented with a single neural network, where different subsets of layers correspond to respective receiver algorithms.

In case of machine learning (ML)-based radio receivers, one or more parts of the radio receiver may be implemented with a neural network (NN), which may be trained for a particular task. This may facilitate improved performance and higher flexibility, as everything is learned directly from transmitted and received data. Neural radio receivers may be implemented for example by training a complete frequency domain receiver. This may be done for example based on deep convolutional neural networks (CNN), which enables to achieve high performance for example in various 5G (5^{th} generation) multiple-input multiple output (MIMO) scenarios.

A challenge with fully learned receivers is that they may require a large amount of computational resources to be run. For example, the highest-order modulations, such as 256-QAM (quadrature amplitude modulation), may be challenging for ML-based receivers, because the may require very high accuracy.

One way to retain the performance also with high-order modulation schemes is to increase the size of the neural network. This may however result in the computational burden to become unpractical in real-time hardware implementation, for example because of tight power and latency budgets. One aspect in developing such ML-based receivers is therefore to find ways to balance between high performance and computational complexity. Example embodiments of the present disclosure address this problem by introducing novel ML-based receiver architecture(s), where expert knowledge is incorporated into the receiver model such that complexity is reduced, while still retaining sufficient flexibility to achieve good performance.

Example embodiments provide a deep learning-based multi-stage equalizer that is able to exceed state-of-the-art radio performance with a large margin. The equalizer may take as input the frequency domain antenna signals and interpolated raw channel estimates and output bit log-likelihood ratios. The deep learning model may be trained end-to-end using backpropagation and stochastic gradient descent (SGD). At least two equalizer stages of the radio receiver may be run sequentially.

According to an example embodiment, a radio receiver may receive data, for example modulation symbols carrying payload data, and reference signals (e.g. pilots). The radio receiver may determine a channel estimate for the received data based on the reference signals and equalize the received data with a sequential plurality of equalization stages. One or more of the equalization stages may comprise: 1) an equalizer configured to determine an equalized representation of input data based a previous channel estimate, and 2) a neural network configured to determine at least a refined channel estimate for a subsequent equalization stage based on the previous channel estimate and the input data. This way the channel estimate may be gradually improved taking into account the determined estimates of the transmitted data, which improves reception performance.

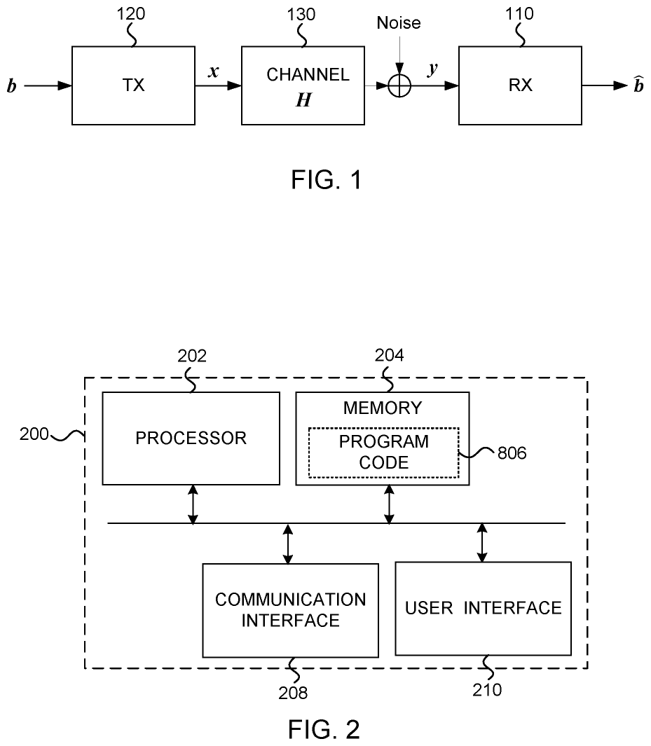

FIG. 1 illustrates an example of a system model for radio transmission. Radio receiver (RX) 110 may receive signals from transmitter (TX) 120 over a radio channel (H) 130. Transmitter 120 may generate the transmitted signal x based on an input bit sequence b, which may comprise a set of bits (e.g. a vector). The input bit sequence b may comprise payload data, for example user data or application data. Transmitter 120 may use any suitable modulation scheme to generate the transmitted signal x, carrying the input bit sequence b.

One example of a modulation scheme is orthogonal frequency division multiplexing (OFDM), where groups of bits may be mapped to complex-valued modulation symbols carried on subcarriers of an OFDM symbol. A subcarrier of an OFDM symbol is an example of a resource element (RE) used to carry data. The transmitted symbol sequence (x) may be therefore defined in frequency domain. It is however possible to use any other suitable modulation scheme, such as for example single-carrier frequency division multiplexing (SC-FDMA), a version of OFDM. It is also possible to apply the disclosed example embodiments to single carrier communications. The transmitted symbol sequence may comprise either frequency domain or time domain modulation symbols (e.g. real or complex-valued symbols from a constellation).

The transmitted signal x may propagate through a multipath radio channel, which may be modelled by channel matrix H. The received signal y may comprise a noisy version of the channel-transformed signal. Radio receiver 110 may demodulate the received signal y and determine an estimate (\hat{b}) of the transmitted bit sequence.

The transmission system may be configured for example based on the 5^{th} generation (5G) digital cellular communication network, as defined by the 3^{rd} Generation Partnership Project (3GPP). In one example, the transmission system may operate according to 3GPP 5G-NR (5G New Radio). It is however appreciated that example embodiments presented herein are not limited to devices configured to operate under this example system and the example embodiments may be applied in any radio receivers, for example receivers configured to operate in any present or future wireless or wired communication networks, or combinations thereof, for example other type of cellular networks, short-range wireless networks, broadcast or multicast networks, or the like.

FIG. 2 illustrates an example embodiment of an apparatus 200, for example radio receiver 110, or an apparatus comprising radio receiver 110, such as for example a mobile device such as a smartphone, an access node of a cellular communication network, or a component or a chipset of a mobile device or access node. Apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. The at least one memory 204 may be configured to store instructions, for example as computer program code or the like, for example operating system software and/or application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable apparatus 200 to transmit and/or receive information to/from other devices. In one example, apparatus 200 may use communication interface 208 to transmit or receive data in accordance with at least one cellular communication protocol. Communication interface 208 may be configured to provide at least one wireless radio connection, such as for example a 3GPP mobile broadband connection (e.g. 3G, 4G, 5G, 6G, or future generation protocols). However, communication interface 208 may be configured to provide one or more other type of connections, for example a wireless local area network (WLAN) connection such as for example standardized by IEEE 202.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. Communication interface 208 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. Radio receiver 110 may be part of communication interface 210.

Apparatus 200 may further comprise a user interface 210 comprising an input device and/or an output device. The input device may take various forms such a keyboard, a touch screen, or one or more embedded control buttons. The output device may for example comprise a display, a speaker, a vibration motor, or the like. The output device may be configured to output data equalized by radio receiver 110 to a user, for example to display received video or image data and/or to output received audio signal(s) via speaker(s) of apparatus 200.

When apparatus 200 is configured to implement some functionality, component(s) of apparatus 200, such as for example the at least one processor 202 and/or the at least one memory 204, may be configured to implement this functionality. Furthermore, when the at least one processor 202 is configured to implement some functionality, this functionality may be implemented using the program code 206 comprised, for example, in the at least one memory 204. Program code 206 is provided as an example of instructions which, when executed by the at least one processor 202, cause performance of apparatus 200.

The functionality described herein may be performed, at least in part, by one or more computer program product components such as software components. According to an embodiment, the apparatus comprises processor(s) or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

Apparatus 200 may comprise for example a computing device such as for example am access node, a base station, a server, a mobile phone, a tablet computer, a laptop, an internet of things (IoT) device, or the like. Examples of IoT devices include, but are not limited to, consumer electronics, wearables, sensors, and smart home appliances. In one example, apparatus 200 may comprise a vehicle such as for example a car. Although apparatus 200 is illustrated as a single device it is appreciated that, wherever applicable, functions of apparatus 200 may be distributed to a plurality of devices, for example to implement example embodiments as a cloud computing service.

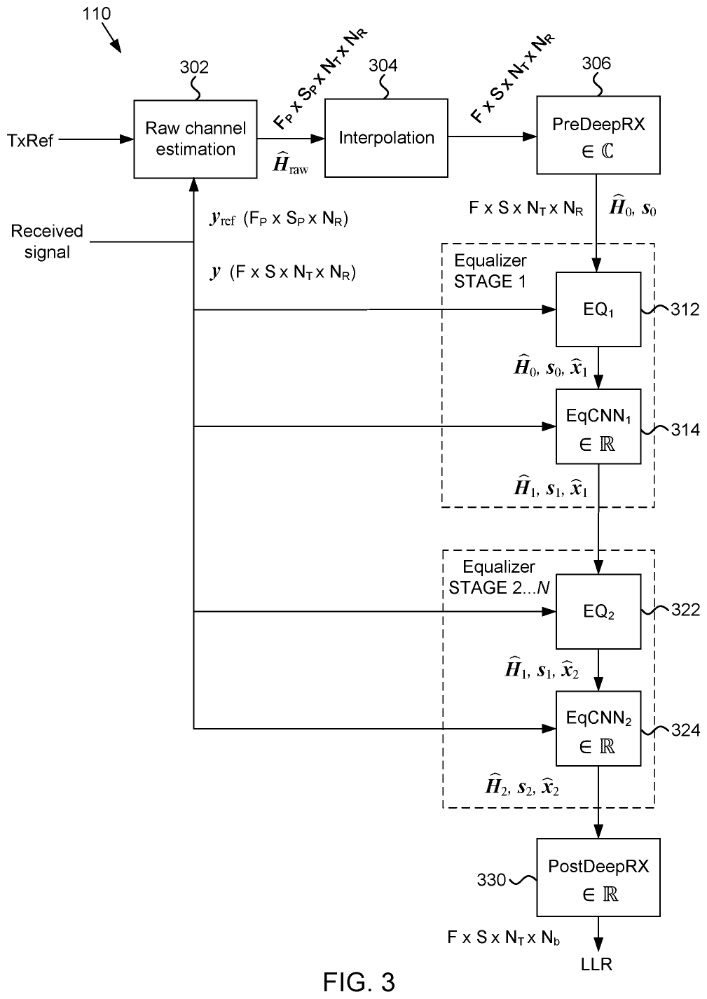

FIG. 3 illustrates an example of a multi-stage equalizer architecture. Radio receiver 110 may receive a signal comprising data, denoted hereinafter by y, and reference signals y_{ref}. A time-domain received signal may be Fourier transformed to obtain the data and the reference signals. The data may be arranged as an array of modulation symbols (e.g. real/complex-valued constellation points). In case of OFDM-based systems, dimensionality of the array may be F×S×N_{T}×N_{R}, where F is the number of subcarriers, S is the number of OFDM symbols (for example 14), N_{T} is the number of MIMO layers (transmit antennas), and N_{R} is the number of receive antennas. In one example, the data array may comprise data of one transmission time interval (TTI). If MIMO is not used, the number of transmit antennas may be equal to one, N_{T}=1. In this case, the number of receive antennas may or may not be equal to one.

The reference signals y_{ref} may comprise received symbols at predetermined reference resource elements (e.g. pilot subcarriers). The reference signals may be formatted as an F_{P}×S_{P}×N_{R} array, where subscript P may refer to number of subcarriers or OFDM symbols carrying pilots (reference signals). Radio receiver 110 may be preconfigured with information about the transmitted reference signals (TxRef). An indication of time-frequency locations of the reference signals may be received from transmitter 120. An example of a reference signal is a demodulation reference signal (DM-RS).

At raw channel estimation block 302, radio receiver 110 may compare the received reference signals y_{ref} to transmitted reference signals (TxRef) and determine a raw channel estimate Ĥ_{raw} for the pilot positions. The raw channel estimate may comprise an F_{P}×S_{P}×N_{T}×N_{R} array. Radio receiver 110 may for example determine the raw channel estimate based on multiplying the received reference signals and expected values of the reference signals (TxRef).

At interpolation block 304, radio receiver 110 may interpolate the raw channel estimate Ĥ_{raw}, for example by nearest neighbourhood interpolation. The channel estimate of each data symbol (RE) may be selected based on the raw estimate of the nearest pilot-carrying resource element. A channel estimate (complex number) may be determined for each modulation symbol of the received signal. The obtained channel estimate may be therefore arranged as an F×S×N_{T}×N_{R} array. Radio receiver may determine a channel estimate for the received data (y) based on the received reference signals (y_{ref}), for example as a result of operations 302 and 304.

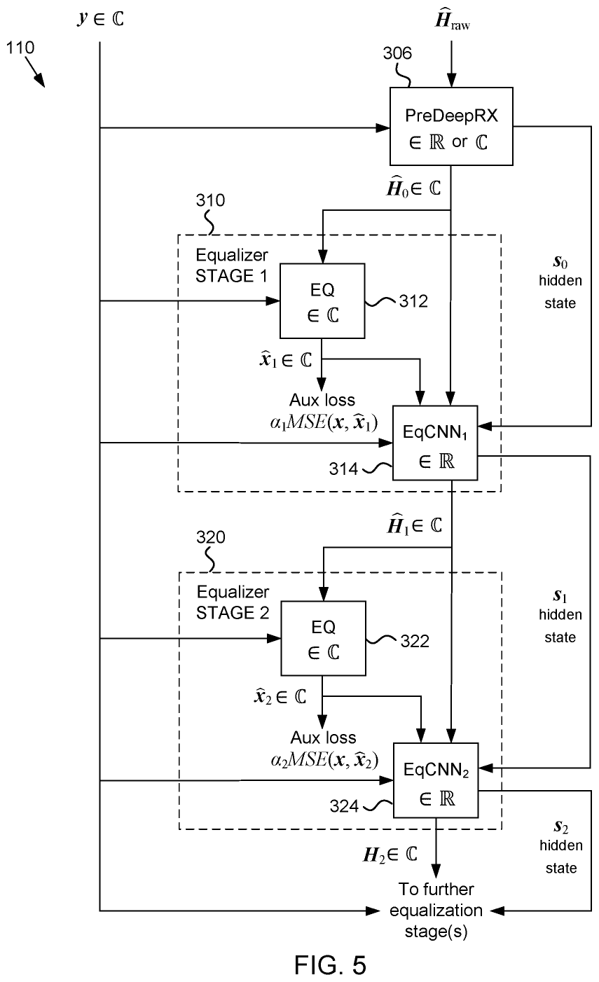

Neural network 306 (PreDeepRX) may comprise a convolutional neural network (e.g. ResNet) configured to process the (interpolated) raw channel estimate and output a refined channel estimate Ĥ₀, which may have the same dimensions as the channel estimate provided as input to neural network 306. Neural network 306 may for example comprise a complex-valued 3-block ResNet with 3×3 filters. In general, parameters of neural network 306 may be complex-valued. It is however possible to use a real-valued neural network, as provided in the example of FIG. 5. Neural network 306 may be trained end-to-end with other learnable parts of radio receiver 110, for example neural networks 314 and 324 (EqCNN₁ and EqCNN₂) of the first and second equalization stages. Pre-processing of the raw channel estimate by neural network 306 may be however optional. Hence, neural network 306 may not be present in all example embodiments.

Neural network 306 may also output a hidden state s₀. The hidden state may be provided to neural network 314 of Equalizer STAGE 1. The hidden state may be provided in any suitable format. For example, the hidden state may be part of the output of neural network 306. The hidden state may be then extracted and processed at Equalizer STAGE 1, for example by neural network 314.

Equalizer STAGE 1 may comprise an equalizer (EQ₁) 312. Equalizer 312 may be a non-trainable (non-ML) equalizer, examples of which include linear minimum mean square error (LMMSE) equalizer and maximal ratio combiner (MRC). The hidden state s₀ may be combined, for example concatenated, with other the input(s) (e.g. y and/or Ĥ₀) of equalizer 312

An LMMSE equalizer may determine an estimate of the transmitted modulation symbols \hat{x} based on

$${\hat{x}}_{ij} = {( {\hat{H}}_{ij}^{H} {\hat{H}}_{ij} + {σ}_{w}^{2} I )}^{- 1} {\hat{H}}_{ij}^{H} {y}_{ij} ,$$

where ( )^{H} denotes Hermitean transpose, σ_{w}² is noise variance, I is an identity matrix, and ( )⁻¹ denotes matrix inversion. Ĥᵢⱼ^{H}∈ [symbol] is a subarray of Ĥ corresponding to the ij-th resource element and i and j denote the subcarrier and OFDM symbol indices, respectively. Soft bits may be then obtained by calculating log-likelihood ratios (LLR) of bits based on \hat{x}, for example by a max-log MAP (maximum a posteriori) demapper. LMMSE provides the benefit of accurate equalization.

An MRC equalizer may perform (partial) equalization based on

$${y}_{ij , MRC} = S {\hat{H}}_{ij}^{H} {y}_{ij} ∈ {ℂ}^{{N}_{T} \times 1} .$$

The output of the MRC transformation, generally operating on the received data y and a channel estimate H, may correspond to transmitted spatial streams. Hence, MRC may provide a partially equalized representation of the received signal. MRC transformation may be applied as a pre-processing stage. Its output may be fed to a neural network for modulation symbol or bit detection. MRC equalization provides the benefit of low complexity, because it may be simple to implement it in hardware.

Equalizer 312 may be also implemented at least partially by a neural network, for example based on a learned multiplicative transformation, which may comprise 1) a sparse selection of input components for multiplication and 2) learned scaling of the imaginary part of its input data, representing a type of generalized complex conjugation. The former facilitates intelligent selection of inputs to multiply, while the latter allows the network to learn more easily, for example, the complex conjugation of the channel coefficients, a feature inspired by the MRC processing. The learned multiplicative transformation may take as input the data provided by neural network 306. The learned multiplicative transformation may take as input the received data y. For example, a concatenation of channel estimate Ĥ₀ and the received data y may be provided as input to the multiplicative transformation. The input of the multiplicative transformation may be denoted by \tilde{Z}.

The learned multiplicative transformation may comprise the following operations:
Expanding channels of \tilde{Z} of the multiplicative transformation with a sparse matrix W₁∈ [symbol] as \tilde{z}_{ij,ex}=W₁\tilde{z}ᵢⱼ, where Mₑₓ is the expanded channel count (Mₑₓ mod 3=0) and Mᵢₙ is the number of channels at the input of the multiplicative transform. This operation may learn to choose which input channels to multiply. Expanding the channels may comprise reshaping the N_{T}×N_{R} input data into one dimension and concatenating the inputs to a single tensor.
Scaling the imaginary part of each channel by \tilde{z}_{ij,sc}=Re[\tilde{z}_{ij,ex}]+w₂⊙Im[\tilde{z}_{ij,ex}], where w₂∈ [symbol] and ⊙ denotes elementwise multiplication.
Partition \tilde{z}_{ij,sc} to three equal size vectors \tilde{z}_{ij,1}, \tilde{z}_{ij,2}, and \tilde{z}_{ij,3}. The output of the learned multiplicative transformation may be obtained by

$${\tilde{y}}_{ij , MP} = [ \begin{matrix}{\tilde{y}}_{ij , 1} ⊙ {\tilde{y}}_{ij , 2} \\ {\tilde{y}}_{ij , 3}\end{matrix} ] ∈ {ℂ}^{{M}_{out} \times 1} ,$$

where

$${M}_{out} = \frac{2}{3} {M}_{ex} .$$

Parameters W₁ and w₂ may be learned during the training procedure. Same weights are used for multiple (e.g all) REs. Having repeated the multiplicative processing for the REs, the resulting array \tilde{Y}_{MP}∈ [symbol] may be fed to neural network 314 (EqCNN₁) for further processing as the equalized representation \hat{x}₁.

An auxiliary loss may be calculated based on difference between the output of equalizer 312 (\hat{x}₁) and the transmitted symbols (x). This loss may be used as one component of the loss function for end-to-end training of the neural network(s) of radio receiver 110, as will be further described below.

In general, equalizer 312 may comprise any suitable type of equalizer, for example any of the following types: LMMSE, MRC, or an equalizer neural network (e.g. learned multiplicative transformation). Different equalizer stages may be implemented with different types of equalizers. In case of an equalizer neural network, one or more layers of equalizer 312 may be shared with other neural network(s) of radio receiver 110, for example any one or more of neural networks 306, 314, 324, or equalizer 322, if comprising a neural network. Thus, radio receiver 110 may be implemented, at least partially, as an iterative receiver. This enables to reduce overall complexity of radio receiver 110. It is however also possible to implement equalizers of different equalization stages, for example equalizers 312 and 322, as separate neural networks or sub-networks, which may not share any layers. This may provide better performance due to higher degree-of-freedom in the overall neural network or combination of neural networks.

Equalizer STAGE 1 may comprise a neural network 314 (EqCNN₁). Neural network 314 may comprise a convolutional neural network, implemented for example with ResNet blocks (e.g. similar to neural network 306). Neural network 314 may or may not share one or more layers with neural network(s) of other equalization stages, for example the subsequent equalizer stage (STAGE 2).

Neural network 314 may be configured to take as input the equalized representation \hat{x}₁ (e.g. equalized modulation symbols) provided by equalizer 312. Neural network 314 may take as input the received data y. Neural network 314 may take as input the channel estimate Ĥ₀ from neural network 306. Neural network 314 may take as input the hidden state s₀ from neural network 306. Alternatively, neural network 314 may perform inference without the hidden state. Inputs of neural network 314 may be combined, for example by concatenation. Combining may be performed before processing of the input data by neural network 314. Same applies to other neural networks of the system. Neural network 314 may be trained as part of the end-to-end training of learnable parts of radio receiver 110.

Neural network 314 (EqCNN₁) may determine a refined channel estimate Ĥ₁, which may be provided to the subsequent equalizer stage (STAGE 2), for example equalizer 322 and/or neural network 324 (EqCNN₂). Neural network 314 may output a hidden state s₁ The hidden state may be provided to block(s) of the subsequent equalizer stage (STAGE 2), for example neural network 324. Neural network 314 may provide as output the equalized representation \hat{x}₁, which may comprise the equalized modulation symbols output by equalizer 312 (e.g. unmodified). Alternatively, for example in case of MRC equalization, neural network 314 may be configured to transform the MRC output, e.g. an estimate of the transmitted spatial streams, to equalized modulation symbols. The equalization task may be divided between equalizer 312 and neural network 314. In this case, the auxiliary loss may be determined from the output of neural network 314. This enables exploiting neural network 314 also for equalization, and not only for refining the channel estimate, which may result in improved equalization performance.

Neural network 314 may be configured to represent nonlinear functions that utilize statistics of the unknown data y as well as the previous channel estimate (denoted generally by Ĥₙ₋₁). Neural network 314 and/or equalizer 312, if implemented as a neural network, may comprise real-valued convolutional neural network(s) with depthwise (separable) convolutions. A depthwise convolution may comprise a spatial convolution performed independently over each channel of input data. A depthwise separable convolution may comprise a depthwise convolution followed by a pointwise convolution. Depthwise separable convolutions may be used for example with a depth multiplier value of 2. This doubles the number of output channels in the depthwise convolution, thereby increasing the number of parameters and improving modelling capability of the neural network. According to experiments using depthwise convolutions improves performance.

Equalizer STAGE 2 may comprise an equalizer 322, for example any of the different types described with reference to equalizer 312. Another auxiliary loss may be calculated based on the difference between the output of equalizer 322 (\hat{x}₂) and the transmitted symbols (x). This loss may be used as another component of the loss function for end-to-end training of the neural network(s) of radio receiver 110.

Again, equalizer 322 may comprise any suitable type of equalizer, for example any of the equalizer types described with reference to equalizer 312. In case of an equalizer neural network, one or more layers of equalizer 322 may be shared with other neural network(s) of radio receiver 110, for example any one or more of neural networks 306, 314, 324 or equalizer 312, if implemented as a neural network. Implementation with separate neural (sub-)networks is another option.

Equalization STAGE 2 may comprise a neural network 324 (EqCNN₂). Neural network 324 may be similar to neural network 314, at least in terms of structure. Learnable parameters may be different. Neural network 324 may take as input the equalized representation \hat{x}₂ provided by equalizer 322. Neural network 324 may take as input the received data y. Neural network 324 may take as input the refined channel estimate Ĥ₁ from neural network 314. Neural network 324 may take as input the hidden state s₁ from neural network 314. Alternatively, neural network 324 may perform inference without the hidden state. Inputs of neural network 324 may be combined as described above, for example by concatenation. Neural network 324 may be trained as part of the end-to-end training of learnable parts of radio receiver 110.

Neural network 324 may determine a refined channel estimate Ĥ₂, which may be provided to neural network 330 (PostDeepRX). Neural network 324 may be similar to neural network 314, for example in terms of structure. Learnable parameters may be different. Neural network 314 may optionally output a hidden state s₂. The hidden state may be provided to neural network 330. Neural network 324 may provide as output the equalized representation \hat{x}₂, which may comprise the equalized modulation symbols output by equalizer 322 (e.g. unmodified) or a transformed representation of the equalized modulation symbols, for example as described with reference to neural network 314. Alternatively, output(s) of neural network 324 may be provided to a subsequent equalizer stage (STAGE 3, not shown) or a non-ML detector configured to detect bits (either hard or soft) based on the estimate of transmitted symbols \hat{x}_{N} provided by the last (N-th) equalization stage.

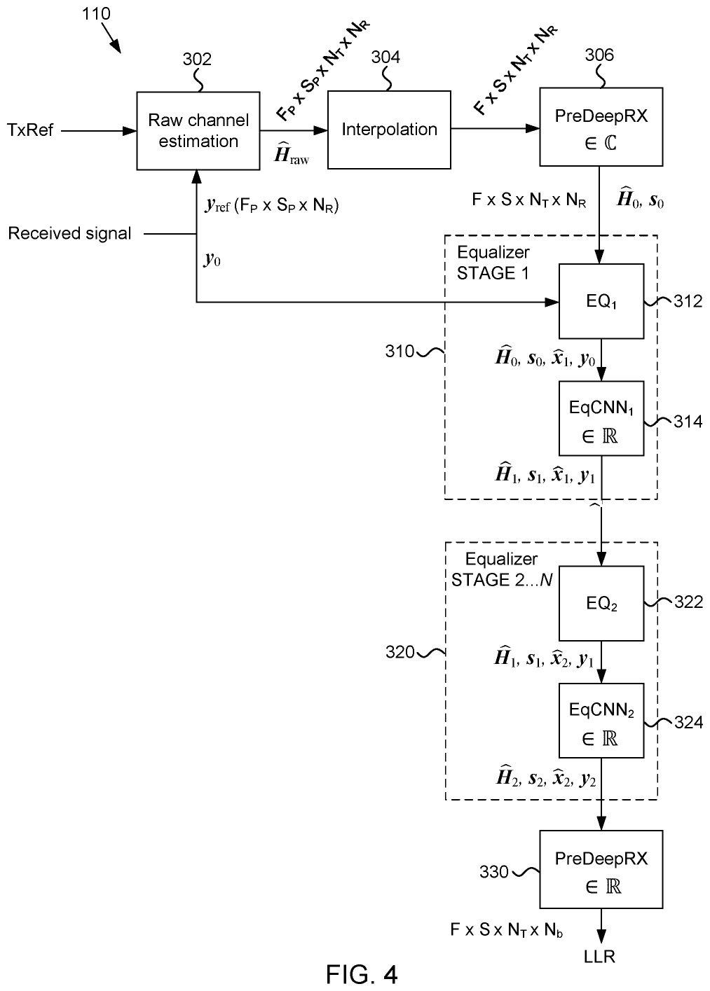

Even though two sequential equalization stages are illustrated in FIG. 3, it is understood that radio receiver 110 may include any suitable number (N) of equalization stages, for example any number between two and seven equalization stages. The number of equalization stages may be dependent on the number of MIMO layers, signal-to-noise ratio (SNR), antennas, or other transmission parameters. Radio receiver 110 may hence equalize the received data with a sequential plurality of equalization stages (e.g. Equalization STAGEs 1 and 2). One or more (or each) of the equalization stages may comprises an equalizer configured to determine an equalized representation of input data (e.g. y) based a previous channel estimate (e.g. Ĥ₀ or Ĥ₁). One or more (or each) of the equalization stages may comprise a neural network (e.g. EqCNN₁ or EqCNN₂) configured to determine a refined channel estimate (e.g. Ĥ₁ or Ĥ₂) for a subsequent equalization stage based on the previous channel estimate and the input data. The neural network may further output a hidden state (e.g. s₁ or s₂) to the subsequent equalization stage, for example an equalizer (e.g. 322) and/or a neural network (e.g. 324) of the subsequent equalization stage. Each equalization stage may receive as input the same received data y. However, an alternative implementation is provided in FIG. 4.

Every learned equalization stage (n) may therefore improve the data estimate \hat{x}ₙ by using the previous channel estimate Ĥₙ₋₁ and the unknown data y. The data estimate \hat{x}ₙ may not necessarily represent the modulation symbols, if those are only processed using learned components. During training, each stage may be penalized, for example by |x−\hat{x}ₙ|². Using \hat{x}ₙ and y, the channel estimate Ĥₙ may be improved at every equalization stage.

Neural network 330 (PostDeepRX) may take as input the equalized representation \hat{x}₂ provided by neural network 324 (or equalizer 322). Neural network 330 may take as input the refined channel estimate Ĥ₂ from neural network 324. Neural network 330 may take as input the hidden state s₂ from neural network 314. Alternatively, neural network 330 may perform inference without the hidden state. Neural network 330 (PostDeepRX) may be similar (e.g. in terms of structure) to neural network 306 (PreDeepRX). In some example embodiments, parameters of neural network 330 may be real-valued. This reduces complexity without resulting in excessive degradation in performance.

In general, neural network 330 may receive its input from the last (e.g. N-th) equalization stage. Neural network 330 may be configured to provide as output the LLRs of the transmitted bits, or any other suitable representation of the transmitted data (e.g. hard bits). The output of neural network 330 may be therefore an F×S×N_{T}×N_{b} array of data (bits), where N_{b} denotes the number of bits corresponding to the array of received data symbols y, for example data of a single TTI.

The output of neural network 330 may be included in the loss function for training the neural network(s) of the reception chain of radio receiver 110. One example, of such loss term may comprise the binary cross-entropy between the transmitted and received bits (e.g. LLRs). If the data is channel coded at transmitter 120, for example by a forward error correction (FEC) encoder such as a low-density parity check (LPDC) encoder, neural network 330 may be configured to perform channel decoding. This may be implemented by comparing the output of neural network 330 to uncoded bits at transmitter 120 at the training phase.

It is however possible to apply a separate (non-ML) channel decoder, e.g. an algorithmic LDPC decoder, to which the output of neural network (or a non-ML detector) is provided. This enables to balance the amount of ML-based functions of radio receiver 110, for example considering the trade-off between complexity and performance.

FIG. 4 illustrates an example of a multi-stage equalizer architecture with update of received data. This equalization architecture may comprise similar blocks as described with reference to FIG. 3. The received data (y) may be provided to the first equalization stage (STAGE 1). The received data may not be directly provided to other equalization stages. The first equalization stage may determine the refined channel estimate Ĥ₁, the hidden state s₁, and/or the equalized representation \hat{x}₁, for example as described with reference to FIG. 3. Equalizer STAGE 1 (e.g. neural network 314) may determine an updated representation y₁ of the received data y₀, for example by equalizer 312. The updated representation of the received data may be provided to the subsequent equalization stage (STAGE 2) as the data input. The original version (y₀) of the received data may not be provided to the subsequent equalization stage.

Equalization STAGE 2 may be implemented as explained with reference to FIG. 3. However, the data input may be taken from the previous equalization stage (STAGE 1). The data input may comprise the updated representation of the received data (y₁) determined by the previous equalization stage. One or more (or each) of the (N) equalization stages may determine an updated representation of the received data, for example similar to Equalization STAGE 1. Hence, the representation of the received data may be improved at the different equalization stages. This may improve accuracy of the equalized representation determined by the subsequent equalization stages.

Neural network(s) of radio receiver 110, configured for example based on the architecture of FIG. 3 or FIG. 4, may be obtained by training the neural network(s) by any suitable training method. Radio receiver 110 may be trained for example using the stochastic gradient descent (SGD) method. The loss function may comprise the output of the radio receiver, for example the LLRs from neural network 330. For example, the output of radio receiver 110 may comprise LLRs of bits carried by the transmitted data symbols (x). The loss function may comprise binary cross entropy determined based on the LLRs, for example by a sigmoid function of the LLRs. The binary cross-entropy (CE) may be expressed for example as

$$CE ( b , \hat{b} ) = - \frac{1}{\#DB} {\sum }_{( i , j ) ∈ D} {\sum }_{l = 0}^{B - 1} ( {b}_{ijl} log {\hat{b}}_{ijl} + ( 1 - {b}_{ijl} ) log ( 1 - {\hat{b}}_{ijl} ) ) ,$$

where D is the set of indices corresponding to REs carrying data, #D is the number of such indices, B is the number of samples in the sample batch and \hat{b}ᵢⱼₗ are the predicted bit probabilities (e.g. \hat{b}ᵢⱼₗ=sigmoid (Lᵢⱼₗ), where Lᵢⱼₗ is the output or LLRs from neural network 330). Alternatively, any other type of output provided by radio receiver 110 (e.g. hard bits) may be used. The loss may be weighted with SNR of the sample. A sample batch may comprise a mini-batch of SGD training, for example B samples, where B is the batch size.

The loss function may comprise a difference between an output of the last (N-th) equalization stage (\hat{x}_{N}) and the transmitted data symbols (x). The difference may for example comprise the mean-square error (MSE) between x and \hat{x}_{N}:

$$MSE ( x , {\hat{x}}_{N} ) = {\vert x , {\hat{x}}_{N} \vert}^{2}$$

MSE may be calculated as a sum over the resource elements, similar to the binary cross-entropy described above.

This enables the output of the last equalization stage, and thereby also the influence of the preceding equalization stages, to be taken into account in training. This may improve performance compared to a system, where radio receiver 110 is trained based on a loss function comprising the output of radio receiver 110 (e.g. the cross-entropy discussed above) and not any loss terms associated with outputs of the equalization stages, which would the simplest example embodiment in this regard. The loss function may comprise differences between outputs of the equalizers (e.g. equalizers 312 and 322) and the transmitted data symbols (x). The differences may for example comprise the mean-square errors (MSE) between x and outputs \hat{x}ₙ of different equalizers of different equalization stages:

$$MSE ( x , {\hat{x}}_{N} ) = {\vert x , {\hat{x}}_{N} \vert}^{2} ,$$

where n may take any two or more values between 1 and N. This enables multiple outputs of the equalization stages to be taken into account in training. This makes the influence of the earlier equalization stages stronger, which may improve performance compared for example to a system, where radio receiver 110 is trained based on a loss function comprising the output of radio receiver 110 (e.g. cross-entropy as described above) and/or the output of the last equalization stage. In one example, the loss may be weighted based on SNR(s) of the sample(s) \hat{x}ₙ. For example, MSE(x, \hat{x}₁) may be weighted with an SNR-dependent factor, which may be separate from the weights α₁ . . . α_{N} described below.

The influence of the individual equalization stages may be however weighted, for example such that weight of the loss terms increases along with the order of the respective equalization stage (e.g. STAGE 1 having the lowest weight and STAGE N having the highest weight). The loss L may be obtained based on a loss function comprising the cross-entropy and a weighted the sum of the differences of the equalization stages:

$$L = CE + {α}_{1} MSE ( x , {\hat{x}}_{1} ) + … + {α}_{N} MSE ( x , {\hat{x}}_{N} ) ,$$

where N is the number of equalization stages and αᵢ, i=1 . . . N are the weights of the equalization stages. As noted above, the MSE losses may be weighted such that the weight of the initial stages are lower, while the weights of the final stages are higher, for example α₁<α₂< . . . <α_{N} or α₁≤α₂≤ . . . ≤α_{N}. This enables to ensure that the trained model is not forced to focus too much on the initial stages, where the accuracy of the equalized representation may be lower (and hence the loss term larger). As noted above, training the neural network(s) of radio receiver 110 may be performed end-to-end, using the same loss function for every equalization stage. In addition to neural networks 314, 324, also the equalizers (e.g. 312, 314), when implemented based on a neural network, may be obtained by training the equalizer neural networks based on the same loss function.

FIG. 5 illustrates an example of data routing at a multi-stage equalizer. This figure is provided for the architecture of FIG. 3, where the same version of the received data y may be provided to different equalization stages.

Neural network 306 (PreDeepRX) may receive the (interpolated) raw channel estimate Ĥ_{aw} and the received data y. Neural network 306 may be real- or complex valued. Using a real-valued neural network may be computationally less complex. Neural network 306 may output a refined channel estimate Ĥ₀. Channel estimates may be complex-valued. Channel estimate Ĥ₀ may be provided to equalizer 312 (EQ₁), as well as neural network 314 (EqCNN₁).

Equalizer 312 may receive the received data y and the refined channel estimate Ĥ₀ and output the equalized representation \hat{x}₁ (e.g. a first estimate of the transmitted symbols), which may be complex-valued. Equalizer 312 may be complex-valued, e.g. perform a complex multiplication for each RE subject to equalization. A first auxiliary loss (e.g. α₁MSE(x, \hat{x}₁)) may be determined based on the output of equalizer 312, for example by MSE as described above. The equalized representation may be provided as an input to neural network 314, which may also receive as input the received data y and hidden state s₀. In the alternative architecture of FIG. 4, neural network 314 may receive an updated version of the received data (y₁) from equalizer 312. Neural network 314 may be real-valued, which enables to reduce complexity. Neural network 314 may output the refined channel estimate Ĥ₁. Neural network 314 may further output hidden state s₁

Data may be routed similarly in Equalization STAGE 2, as illustrated in FIG. 5. Equalizer 322 may receive the received data y and the refined channel estimate Ĥ₁ and output the equalized representation \hat{x}₂ (e.g. a second estimate of the transmitted symbols). A second auxiliary loss (e.g. α₂MSE(x, \hat{x}₂)) may be determined based on the output of equalizer 322. The equalized representation may be provided as an input to neural network 324, which may also receive as input the received data y and hidden state s₁ from neural network 314. In the alternative architecture of FIG. 4, neural network 324 may receive an updated version of the received data (y₂) from equalizer 322. Neural network 314 may output the refined channel estimate Ĥ₂. Neural network 314 may further output hidden state s₂.

Equalization STAGE 2 may output the second auxiliary loss (e.g. α₂MSE(x, \hat{x}₂)), the refined channel estimate Ĥ₂, and hidden state s₂ to further equalization stages. The last equalization stage (N) may output the equalized representation \hat{x}_{N} to further receiver stages, for example neural network 330 (PostDeepRX). Optionally, the last equalization stage may output hidden state s_{N} to further (neural) processing stages of radio receiver 110 (e.g. neural network 330).

Example embodiments of the present disclosure provide a novel learned multi-stage receiver model, which may be trained end-to-end together with other parts of radio receiver 110. Outputs of the individual equalization (EQ) stages may be included in the overall loss function. This may be done for example by calculating mean squared error (MSE) loss between transmitted symbols and the estimated symbols of each EQ stage. This leads to a very explainable model.

Each individual equalization stage may comprise a cascade of an equalization operation and a trainable CNN. The equalization operation may be predefined. For example, the equalization operation may comprise maximal-ratio combining (MRC) or linear minimum mean square error (LMMSE) equalization, or even a fully-learned multiplicative transformation. Both the received antenna data (y) as well as the previous stage's channel and data estimates may be provided as input to a subsequent equalization stage. This approach may include information transfer between the (C)NNs included in the equalization stages using a hidden state variable.

Example embodiments of the present disclosure may provide the following benefits:
Improved radio performance vs complexity. Overall, the disclosed methods improve the radio performance of neural network based receiver models given the same complexity in TFLOPS (tera floating-point operations per second). The amount of TFLOPS may be considered as a significant metric for feasibility of radio receiver 110 to operate within given latency and power budgets. This may be for example the case when integrating neural network-based receivers in chipsets.
Excellent low-pilot performance. In addition, example embodiments of the present disclosure provide state-of-the-art radio performance, for example for low-pilot cases, such as a one-pilot case. In this case, it may be beneficial to iterate channel estimation and equalization with the unknown data, since the channel evolution in time may be only observable in the unknown data. In a low-pilot case only few symbols (e.g. 1-5%) in the resource element grid may include pilots. In a one-pilot case, one OFDM symbol contains pilots on multiple subcarriers and neighbouring OFDM symbols do not include pilots.
Explainability. The way the neural network is structured, with equalization blocks together with the auxiliary losses, results in an explainable model. It is for example possible to explore the intermediate estimated channel coefficients and data symbols by looking at activations inside the equalizer blocks. This may beneficial for many reasons, e.g., integration to other processing blocks and exploring problematic transmissions. This is in stark contrast with other type of CNN receivers, where all processing may be implicit and therefore very difficult to probe by looking at the activations.

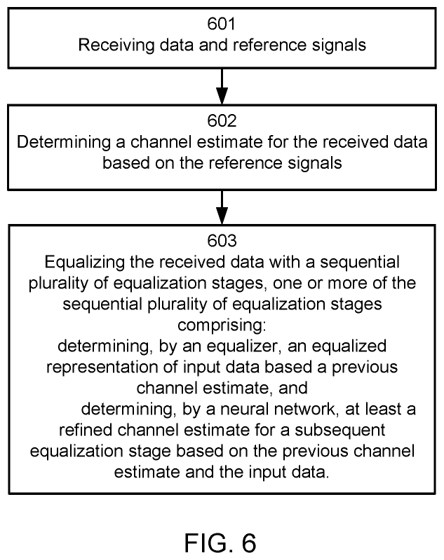

FIG. 6 illustrates an example of a method for equalizing received data.

At 601, the method may comprise receiving data and reference signals;

At 602, the method may comprise determining a channel estimate for the received data based on the reference signals.

At 603, the method may comprise equalizing the received data with a sequential plurality of equalization stages, one or more of the sequential plurality of equalization stages comprising: determining, by an equalizer, an equalized representation of input data based a previous channel estimate, and determining, by a neural network, at least a refined channel estimate for a subsequent equalization stage based on the previous channel estimate and the input data.

Further features of the method directly result from the functionalities and parameters of radio receiver 110, or in general apparatus 200, as described in the appended claims and throughout the specification, and are therefore not repeated here. Different variations of the method may be also applied, as described in connection with the various example embodiments.

An apparatus may be configured to perform or cause performance of any aspect of the method(s) described herein. Further, a computer program or a computer program product may comprise instructions for causing, when executed, an apparatus to perform any aspect of the method(s) described herein. Further, an apparatus may comprise means for performing any aspect of the method(s) described herein. In one example, the means comprises the at least one processor 202, the at least one memory 204 storing instructions that, when executed by the at least one processor 202, cause apparatus 200 to perform the method.

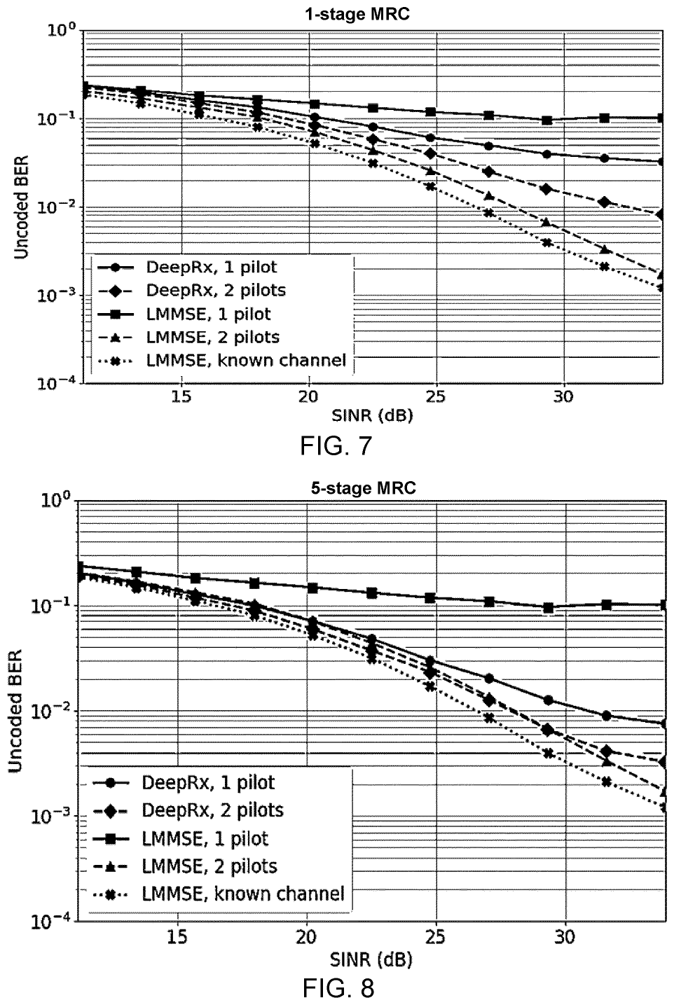

FIG. 7 and FIG. 8 illustrate simulation results in case of 1-stage and 5-stage MRCS, respectively. Uncoded bit error rate (BER) is plotted with respect to signal-to-interference-plus-noise ratio (SINR). The simulation results illustrate benefits of the disclosed multi-stage architecture. Results for the 1-stage architecture represent the baseline as it corresponds to a non-multi-stage neural network based architecture (“DeepRX”). Results for LMMS are provided for reference. Overall, the results show that multi-stage equalization improves the radio performance (given the same complexity in TFLOPS). Performance improvement for the 5-stage architecture is most significant for the 1-pilot case, because the multi-stage procedure is able to obtain an accurate channel estimate even if the raw channel estimate were very noisy, which is the case in the 1-pilot setup.

Any range or device value given herein may be extended or altered without losing the effect sought. Also, any embodiment may be combined with another embodiment unless explicitly disallowed. Even though some example embodiments have been described to be performed ‘based on’ a particular feature, it is understood that the example embodiment in question may be performed ‘by’ that feature.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A radio receiver, comprising:
at least one processor; and at least one memory storing instructions that, when executed by the at least one processor, cause the radio receiver at least to:
receive data and reference signals;
determine a channel estimate for the received data based on the reference signals; and
equalize the received data with a sequential plurality of equalization stages, one or more of the sequential plurality of equalization stages comprising:
an equalizer configured to determine an equalized representation of input data based a previous channel estimate, and
a neural network configured to determine at least a refined channel estimate for a subsequent equalization stage based on the previous channel estimate and the input data.

2. The radio receiver according to claim 1, wherein the neural network is configured to output a hidden state to a neural network of the subsequent equalization stage.

3. The radio receiver according to claim 1, wherein the input data of the one or more of the sequential plurality of equalization stages comprises the received data.

4. The radio receiver according to claim 1, wherein one or more of the sequential plurality of equalization stages is configured to determine an updated representation of the received data for the subsequent equalization stage, and wherein the input data of the subsequent equalization stage comprises the updated representation of the received data.

5. The radio receiver according to claim 1, wherein the neural network is obtainable by training the neural network based on a loss function comprising:
an output of the radio receiver, and
a difference between an output of the sequential plurality of equalization stages and transmitted data symbols.

6. The radio receiver according to claim 1, wherein the neural network is obtainable by training the neural network based on a loss function comprising:
an output of the radio receiver, and
differences between outputs of the equalizers of the sequential plurality of equalization stages and transmitted data symbols.

7. The radio receiver according to claim 6, wherein the loss function comprises weights for the differences between the outputs of the equalizers and transmitted data symbols, wherein the weights increase along with an order of equalization stage.

8. The radio receiver according to claim 1, wherein the loss function comprises a minimum mean square error between an output of at least one of the equalizers of the plurality of equalization stages and the transmitted data symbols.

9. The radio receiver according to claim 5, wherein the output of the radio receiver comprises log-likelihood ratios of bits carried by the transmitted data symbols, and wherein the loss function comprises a binary cross entropy of a sigmoid function of the log-likelihood ratios.

10. The radio receiver according to claim 1, wherein the equalizer comprises a non-trainable equalizer.

11. The radio receiver according to claim 10, wherein the non-trainable equalizer comprises a maximum-ratio combiner or a linear minimum mean square error equalizer.

12. The radio receiver according to claim 1, wherein the equalizer comprises an equalizer neural network.

13. The radio receiver according to claim 12, wherein the equalizer neural network is obtainable by training the equalizer neural network based on the loss function.

14. The radio receiver according to claim 1, wherein the neural network and/or the equalizer neural network comprise a real-valued convolutional neural network with depthwise convolutions.

15. The radio receiver according to claim 1, wherein at least two of the equalizers of the sequential plurality of equalization stages are of different types, comprise separate neural networks or sub networks, or include shared neural network layers.

16. The radio receiver according to claim 1, wherein the radio receiver comprises a mobile device or an access node.

17. A method, comprising:
receiving data and reference signals;
determining a channel estimate for the received data based on the reference signals; and
equalizing the received data with a sequential plurality of equalization stages, one or more of the sequential plurality of equalization stages comprising:
determining, by an equalizer, an equalized representation of input data based a previous channel estimate, and
determining, by a neural network, at least a refined channel estimate for a subsequent equalization stage based on the previous channel estimate and the input data.

18. The method according to claim 17, further comprising:
outputting, by the neural network, a hidden state to a neural network of the subsequent equalization stage.

19. The method according to claim 17, wherein the input data of the one or more of the sequential plurality of equalization stages comprises the received data.

20-32. (canceled)

33. A computer program comprising instructions for causing an apparatus to perform at least the following:
receiving data and reference signals;
determining a channel estimate for the received data based on the reference signals; and
equalizing the received data with a sequential plurality of equalization stages, one or more of the sequential plurality of equalization stages comprising:
determining an equalized representation of input data based a previous channel estimate, and
determining, by a neural network, at least a refined channel estimate for a subsequent equalization stage based on the previous channel estimate and the input data.

34. (canceled)
